(19) United States
(12) Patent Application Publication
(10) Pub. No.: US 2018/0276601 A1
(43) Pub. Date: Sep. 27, 2018

(54) APPLICATION PROGRAM INTERFACES, PORTALS, AND USER INTERFACES FOR MOBILE DEVICE MANAGEMENT

(71) Applicant: Mobile reCell, Carmel, IN (US)

(72) Inventors: Nathan Edward Poynter, Indianapolis, IN (US); Benjamin Michael Jones, Indianapolis, IN (US)

(21) Appl. No.: 15/874,323

(22) Filed: Jan. 18, 2018

Related U.S. Application Data
(60) Provisional application No. 62/447,775, filed on Jan. 18, 2017.

(51) Int. Cl. G06Q 10/08

(52) U.S. Cl. CPC G06Q 10/087; G06Q 10/0833

(57) ABSTRACT

A system includes a customer administration portal communicatively coupled to a customer administration interface, a mobile device data application program interface (API), and a tracking API. The customer administration portal is configured to receive information corresponding to each of a plurality of mobile devices via the mobile device data API. The customer administration portal is configured to receive a tracking code associated with each of the plurality of mobile devices and a location of each of the plurality of mobile devices via the tracking API. The customer administration portal is configured to associate the information corresponding to each of the plurality of mobile devices with the tracking code and the location of each of the plurality of mobile devices.

### SUMMARY

In certain embodiments, a system includes a customer administration portal communicatively coupled to a customer administration interface, a mobile device data application program interface (API), and a tracking API. The customer administration portal is configured to receive information corresponding to each of a plurality of mobile devices via the mobile device data API. The customer administration portal is configured to receive a tracking code associated with each of the plurality of mobile devices and a location of each of the plurality of mobile devices via the tracking API. The customer administration portal is configured to associate the information corresponding to each of the plurality of mobile devices with the tracking code and the location of each of the plurality of mobile devices. The customer administration interface is configured to generate a display of the location of each of the plurality of mobile devices, the tracking code of each of the plurality of mobile devices, and at least a portion of the received data corresponding to each of the plurality of mobile devices.

In certain embodiments, a method includes receiving requests to return a plurality of mobile devices and receiving data corresponding to each of the plurality of mobile devices in response to receiving the requests. The method further includes, in response to receiving the request, associating a tracking code for each of the plurality mobile devices with the received data that corresponds to each of the plurality of mobile devices. The method further includes initiating creation of a logistics label associated with the tracking code of each of the plurality of mobile devices and tracking a location of each of the plurality of mobile devices. The method includes displaying, through a user interface, the location of each of the plurality of mobile devices, the tracking code of each of the plurality of mobile devices, and at least a portion of the received data corresponding to each of the plurality of mobile devices.

While multiple embodiments are disclosed, still other embodiments of the present invention will become apparent to those skilled in the art from the following detailed description, which shows and describes illustrative embodiments of the invention. Accordingly, the drawings and detailed description are to be regarded as illustrative in nature and not restrictive.

### BRIEF DESCRIPTION OF THE DRAWINGS

FIG. 1 shows an asset management environment including a mobile device management system, in accordance with certain embodiments of the present disclosure.

FIG. 2 shows a diagram of the mobile device management system of FIG. 1.

FIG. 3A shows a representation of a graphical user interface, in accordance with certain embodiments of the present disclosure.

FIG. 3B shows a representation of a graphical user interface, in accordance with certain embodiments of the present disclosure.

FIG. 4 shows a block representation of steps of a method, in accordance with certain embodiments of the present disclosure.

While the disclosure is amenable to various modifications and alternative forms, specific embodiments have been shown by way of example in the drawings and are described in detail below. The intention, however, is not to limit the disclosure to the particular embodiments described but instead is intended to cover all modifications, equivalents, and alternatives falling within the scope the appended claims.

### DETAILED DESCRIPTION

Organizations routinely provide their employees with mobile devices (e.g., mobile phones, tablets), which need to be replaced from time to time. To be environmentally and economically efficient when replacing old mobile devices, an old mobile device should be recycled and/or resold when an employee receives a new mobile device. The inventors of the present disclosure developed systems and methods that address the lack of accountability, transparency, and efficiency with corporate mobile device replacement systems and processes.

Some organizations collect mobile devices internally and then ship the mobile devices to a traditional recycling and repair company. This approach lacks transparency because it is unclear ahead of time what price will be paid for the mobile devices or whether the price offered is a good price compared to current market values. This approach also lacks accountability because it may be unclear which employees have yet to turn in their old mobile devices, which employees have turned in their mobile devices, and at what stage in the process the mobile devices are in at any given time.

Other organizations collect mobile devices internally and then ship the mobile devices to an asset buy-back company. This approach lacks transparency because it is unclear whether the price offered by the asset buy-back company is a good price compared to current market values, what mobile devices have been sent by employees and received by the asset buy-back company, what devices have been processed and paid for by the asset buy-back company, and whether the asset buy- back company honors the offered price.

The above-described approaches also lack efficiency because responsibility of managing an organization's mobile devices typically falls on individuals in an organization's IT department, which must physically collect and store old mobile devices, manually record information about the mobile devices into a spreadsheet or the like, negotiate with the potential purchasers, manually package the mobile devices, and manually schedule shipment of the mobile devices.

Certain embodiments of the present disclosure are accordingly directed to systems and methods, including graphical user interfaces and application program interfaces, for managing asset recovery for mobile devices for organizations. Certain embodiments of the present disclosure are particularly useful for managing returns, processing, tracking, and payments for a large number of mobile devices.

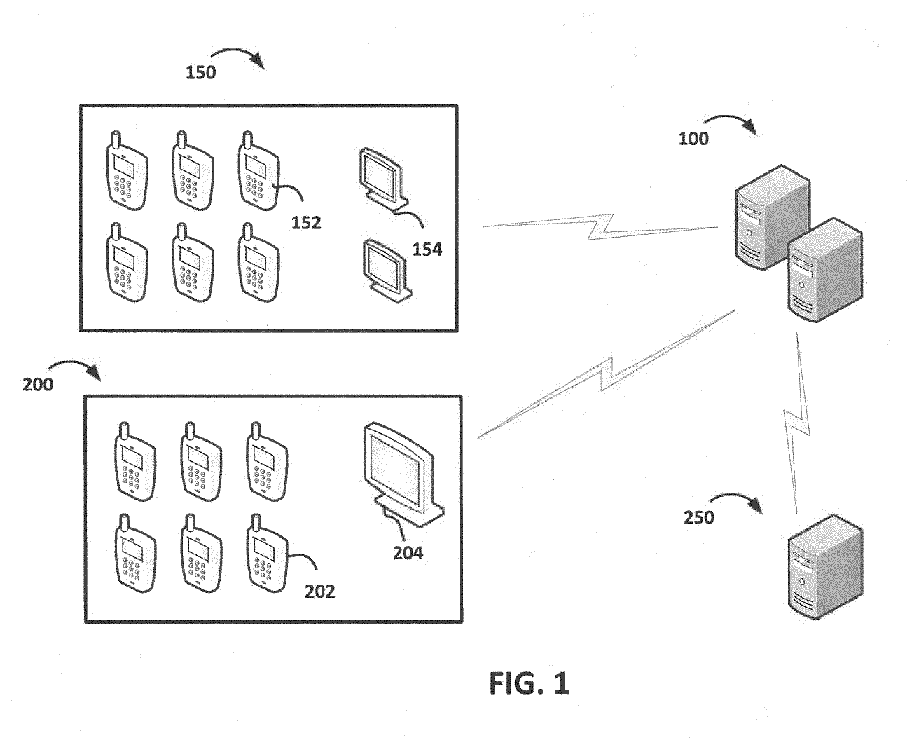

FIG. 1 shows an environment in which a mobile device management system 100 can be used. The mobile device management system 100 is shown as being communicatively coupled to an organization 150, a processing center 200, and one or more databases 250.

The organization 150 includes a plurality of mobile devices 152 that may need to be replaced with newer mobile devices. The organization 150 also includes computing devices 154 that may communicate with the system 100. In some embodiments, the organization 150 communicates with the system 100 indirectly through a third party, such as an enterprise mobility management platform or wireless carrier. In such embodiments, the third party may have computing devices 154 that communicate with the system 100.

The processing center 200 receives mobile devices 202 from an organization's employees and processes the mobile devices 202 for resale, repair, and recycling. The processing center 200 also includes computing devices 204 that may communicate with the system 100.

The one or more databases 250 can include third-party databases that communicate with the system 100 to receive requests for data and transmit the requested data to the system 100. The one or more databases 250 can be databases used by enterprise mobility management platforms and/or wireless carriers.

The system 100, described and shown in more detail below and in the figures, is configured to carry out a variety of functions that improve managing mobile device replacement for organizations.

The system 100 is configured to receive data associated with a plurality of mobile devices. The data can include, but is not limited to, information about the mobile device's user (e.g., an organization's employee) such as the employee's name, address, and e-mail address; information about the mobile device itself including the make, model, serial number, and international mobile equipment identity number; and information about the mobile device return transaction including the date and time. In some embodiments, data is received from an organization's or intermediate company's mobility management program (e.g., programs run on computing devices 154 and/or stored in the one or more databases 250) via application program interfaces (APIs). In some embodiments, the data is received from a carrier network's database (e.g., one or more databases 250) via an API. In some embodiments, the data is received after an organization entered data into a user interface coupled to the system 100. The system 100 can be configured to receive data from each of the sources, which may be different for different customers.

Once data about a mobile device is received by the system 100, a tracking code (e.g., numbers, symbols, letters, bar codes, and combinations of such) can be generated and associated with each mobile device's data. In some embodiments, each mobile device has its own tracking code. As such, the tracking code can be used throughout the mobile device return process to track progress of an individual mobile device. The tracking code and associated mobile device data is stored in the system 100. In some embodiments, the tracking code is associated with a specific logistics company such as Fedex or UPS.

The system 100 can then initiate transmission of a tracking label (e.g., shipping label with address of the processing center 200, for example)—which can be an electronic or physical label—that is associated with the tracking code. For example, the tracking label can be sent to an end user (e.g., mobile device user, organization's IT or asset recovery department). In some embodiments, the tracking label is transmitted by shipping a return shipping box with the tracking label to the end user. In other embodiments, the tracking label is e-mailed to or otherwise made available to download by the end user so that the end user can ship the mobile device. In some embodiments, the tracking code and the tracking label are generated at substantially the same time.

Initiating transmission of the tracking label (whether by e-mail, shipping a return box, etc.) can be done automatically in response to data received by one or more APIs and data generated and transmitted in response to the received data. For example, upon receiving data (via an API) indicating that a tracking code has been generated for a given mobile device, the API can generate a unique identification code associated with the tracking code. The unique identification code can be transmitted (via the API) to a third party responsible for automatically sending e-mails (e.g., e-mails with tracking labels or url links to downloadable tracking labels) to an organization's employees and used to associate an individual mobile device with the tracking code, which is already associated with data about an individual mobile device. As such, the unique identification code is recognized by the system 100 and can be used in conjunction with various functions of the system 100. In some embodiments, the unique identification code is included in a url link itself.

The mobile device management system 100 can track the location of each mobile device once it is shipped. For example, as the mobile device is shipped from one facility to another in a logistics company's network, the logistics company can transmit information about the location of the mobile device in real-time to the system via an API.

Once the mobile device is delivered to its destination (e.g., processing center 200), the system 100 can receive an indication that the mobile device has been received and the mobile device can be processed. Processing includes determining the condition of the mobile device, removing data from the mobile device, and/or destroying the mobile device. Once the mobile device is processed, payment can be transmitted to the organization.

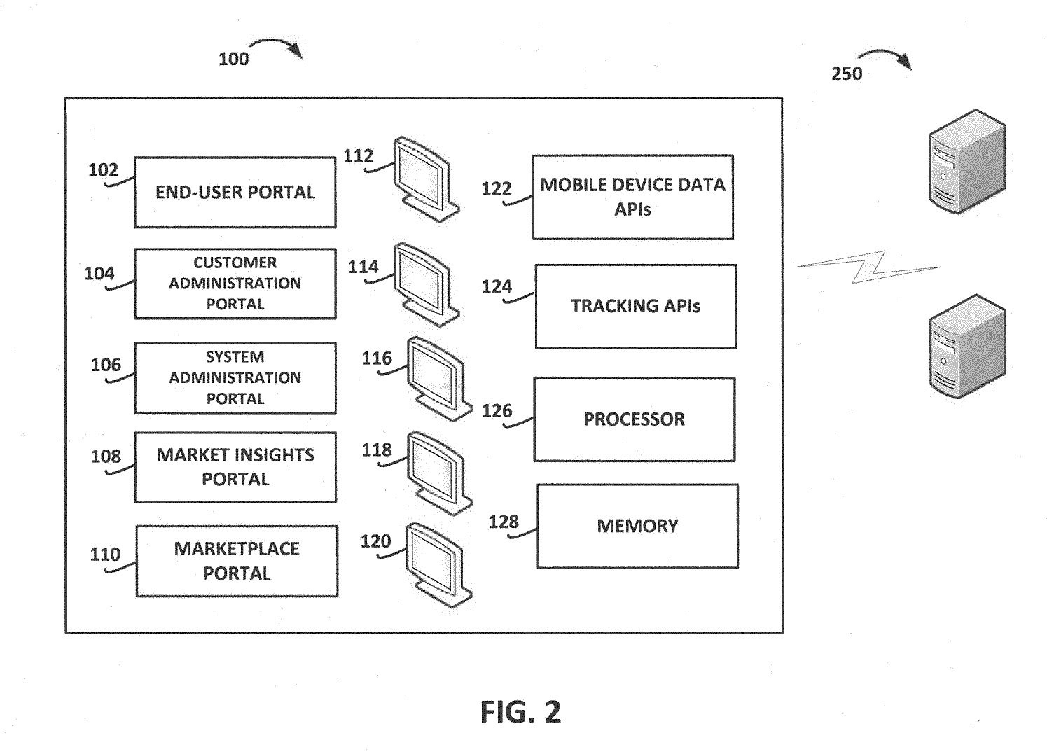

FIG. 2 shows the mobile device management system 100 including various portals (i.e., an end-user (or customer) portal 102, a customer administration portal 104, a system administration portal 106, market insights portal 108, and a marketplace portal 110). The system 100 can provide users access to various user interfaces (i.e., an end-user (or customer) interface 112, a customer administrative interface 114, a system administration interface 116, a market insight interface 118, and a marketplace interface 120). The system 100 also includes APIs (e.g., mobile device data APIs 122 and tracking APIs 124), at least one processor 126, and at least one memory 128.

The end-user interface 112 is intended to give users, such as employees who need to turn in an old mobile device, access to the end-user portal 102. The end- user portal 102 (and end-user interface 112) gives users access to the initial stages of the mobile device return process. In some embodiments, the end-user interface 112 allows users to initiate return of their mobile device. In other embodiments, the return process is automatically initiated or initiated by someone other than the employee with the to-be-replaced mobile device. The end-user interface 112 can allow users to enter information about themselves (e.g., names, address, e-mail address, employee identification code) and information about their mobile device (e.g., make, model, condition). In some embodiments, information about the employee and mobile device is received from other sources such as an organization's or intermediate company's mobility management program or a carrier network's database via an API (e.g., the mobile device data APIs 122).

The end-user interface 112 can allow users to generate and/or download a tracking label with a tracking code (e.g., numbers, symbols, letters, bar codes, and combinations of such) or request that a shipping box with a tracking label and tracking code be sent to the user. The tracking label can be printed and attached to a shipping box to send the old mobile device to a desired destination (e.g., the processing center 200). As mentioned above, tracking codes can be used throughout the mobile device return process to track progress of an individual mobile device. For example, the tracking label can also be attached to a container (e.g., a bag) or a tag that will follow the mobile device throughout the mobile device return process, even if the mobile device is removed from the initial shipping box. The tracking code and associated mobile device data are stored in the system 100.

As mentioned above, in some embodiments, the tracking label can be transmitted to the end user automatically, such as in response to the system 100 receiving data from one or more APIs. The end user may only receive an e-mail with an attached tracking label or a url linking to a tracking label. The e-mail can be generated and transmitted by the system 100 or by the system 100 in conjunction with a third party enterprise mobility software or platform (e.g., computing devices 154 and/or one or more databases 250). When working in conjunction with a third party software or platform, the system 100 can generate a unique identification code that is associated with the tracking code and/or data about an individual mobile device and transmit the unique identification code to the third party program. The unique identification code can be used by the third party program and end user to communicate and interact with the system 100.

Once a user ships their mobile device in a shipping box with the tracking label and tracking code, the location and progress of mobile device through the return process can be tracked via the customer administration portal 104 and customer administrative interface 114.

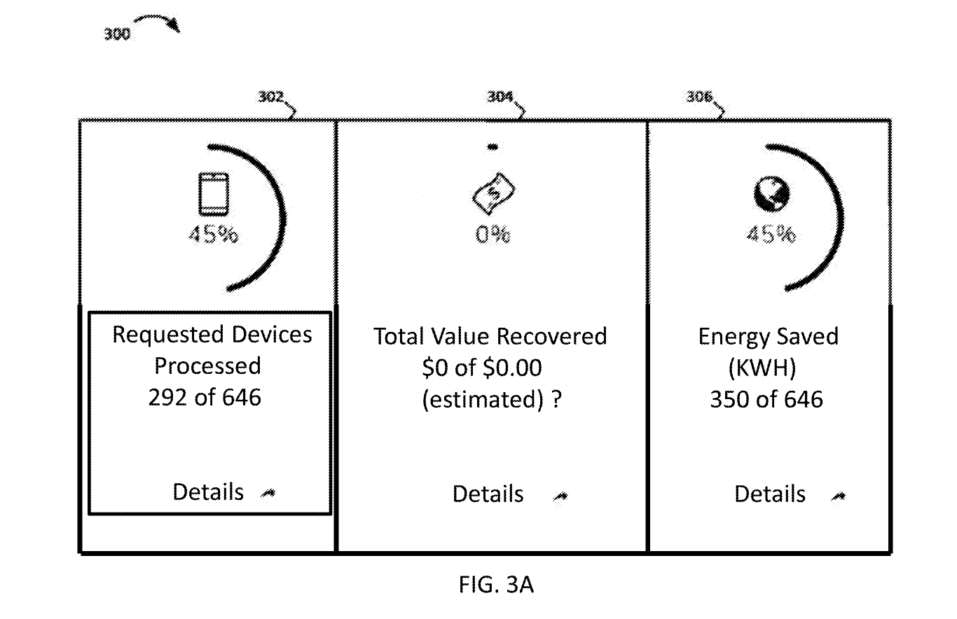

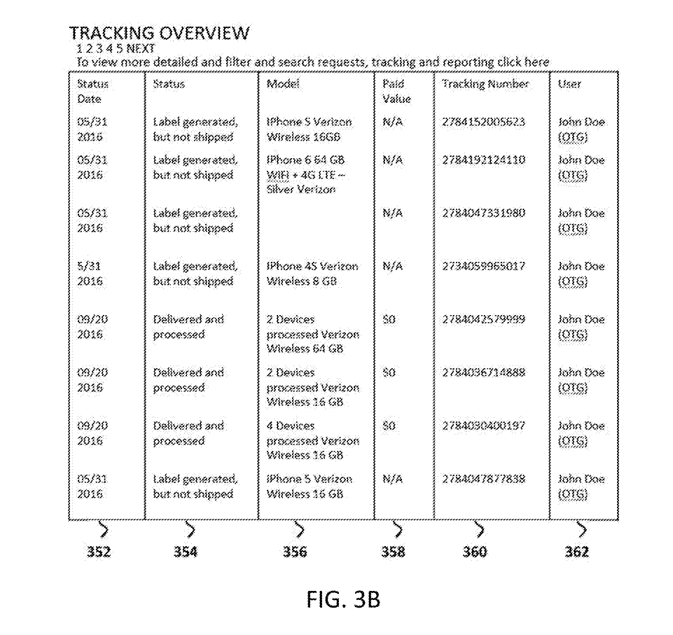

The customer administrative interface 114 (shown in more detail in FIGS. 3A and 3B) is intended to give users (e.g. employees in an organization's IT or asset- recovery departments, providers of enterprise mobility management services and software to organizations) access to the customer administration portal 104. The customer administration portal 104 (and customer administrative interface 114) gives an organization real-time visibility into various aspects of its mobile device returns. FIG. 3A shows a dashboard 300 that can be accessed through the customer administrative interface 114 and customized on a customer-by-customer basis.

The dashboard 300 shown features real-time summaries of an organization's mobile device return process. For example, graphic 302 shows the percentage of mobile devices that have been requested for replacement versus the number of mobile devices actually received and processed. Graphic 304 shows the amount of money the organization has received for its returned mobile devices. Graphic 306 shows the energy saved. For example, graphic 304 represents an amount of energy in kilowatt hours saved by recycling mobile devices. The saved energy graphic 304 can be based on information published by the EPA. In some embodiments, the dashboard can display the cumulative estimated value of mobile devices that have been and have not been processed so that the organization has insight into the value of future returns.

In other examples, the customer administrative interface 114 can list an organization's mobile devices involved in the mobile device return process and show each mobile device's progress and location in the mobile device return process. FIG. 3B shows a summary 350 and status of an organization's mobile devices that have been or should be returned. The summary 350 can be accessed through the customer administrative interface 114. As will be described below, the summary 350 can be customized by various reporting and sorting functions.

The summary 350 is shown with a status date column 352 showing the date of the last update by mobile device. The status column 354 shows the current status of each mobile device. For example, the customer administrative interface 114, via the summary 350, gives users insight into which mobile devices are in transit to the desired destination (e.g., the processing center 200), which mobile devices have been received by the processing center 200, which mobile devices are being processed by the processing center 200, and which mobile devices have been processed and paid for.

The summary 350 also includes a model column 356, which identifies the make, model, and storage capacity of each mobile device. The value paid column 358 displays the price paid for each processed mobile device. The tracking number column 360 displays the tracking code associated with each mobile device. The user column 362 displays the user (e.g., an organization's employee) associated with each mobile device. As mentioned above, because each mobile device is associated with a tracking code, the summary 350 can associate information about the mobile device (e.g., user, make, model, storage capacity) with the shipping status of the of mobile device.

In some embodiments, the system 100 (using data from the customer administration portal 104) is configured to determine which mobile devices have been identified to be replaced but have not yet been shipped. For example, the system 100 can determine if, for a given mobile device, the mobile device return process has been initiated but the mobile device has not been shipped. The system 100 can send automatic periodic reminders to employees who need to ship their mobile devices. The customer administrative interface 114 can show administrators which mobile device and employees need to be reminded. Insight into unreturned mobile devices and the ability to identify which employees have not yet shipped their mobile devices—at an organization level via the customer administration portal 104 and customer administrative interface 114—can increase the rate of returned mobile devices for an organization and therefore increase an organization's overall return on its assets.

The customer administrative interface 114 can provide users the ability to search and filter data and generate reports regarding an organization's mobile device return. For example, as mentioned above, reports can be automatically generated to identify unreturned mobile devices. Other examples include the ability to filter and sort data by received mobile devices, latest-returned mobile devices, various tracking stages, purchase order number, various dates, and end-user location among other categories of data. Through the customer administrative interface 114, users can search by tracking number, employee name, employee number, and mobile device model and make, among other categories of data.

The customer administration portal 104 can be configured to feed, in real- time, data to programs external to the customer administration portal 104. For example, as mentioned above, users can identify which employees need to be reminded to return their mobile device.

The APIs 122 and 124 help provide users via the various interfaces (particularly the customer administration interface 114) with a single view or dashboard with data from a variety of sources. Further, the APIs 122 and 124 assist in providing users the ability to generate reports. The APIs 122 and 124 also allow the system 100 to receive data, in real-time, from other sources and trigger actions based on others' data. The APIs 122 and 124 help integrate features and data from various sources into the system 100.

For example, the mobile device data APIs 122 can be used with the system 100 to integrate a third party's enterprise mobility management software or mobile device management software, an organization's asset database, a carrier network's database, and the like. The system 100, via the mobile device data APIs 122, can receive data regarding an organization's mobile devices and employees. In some embodiments, upon the system 100 receiving a request to initiate the mobile device return process for a user's mobile device, the system 100 can request data, via the mobile device data APIs 122, about the mobile device (e.g., make, model, storage) and the employee assigned the to-be-returned mobile device. The system 100 can be configured to automatically request and receive such data when a mobile device return is initiated.

The tracking APIs 124 can be used to request and receive data from a logistic company's package tracking system. As mentioned above, one of the many features of the system 100 is to identify which mobile devices have been identified to be replaced but have not yet shipped. Despite not being shipped, those mobile devices may have an associated tracking code. The tracking APIs 124 can assist with identifying which mobile devices have an associated tracking code but have not been received by the logistic company. The tracking APIs 124 can also assist with sending tracking labels (with tracking codes associated with mobile devices) to end users via e-mail or physical mail. The process of sending the tracking labels to end users can be triggered automatically upon receiving a tracking code via the tracking APIs 124.

Once a mobile device is shipped, the tracking APIs 124 provide real-time updates to the system 100 regarding the mobile device's location in the shipping channel. The data received by the tracking APIs 124 is associated with an individual mobile device by the tracking code, which is associated with information (e.g., make, model) about the mobile device. In some embodiments, the data received by the tracking APIs 124 is stored by the system 100.

Although FIG. 2 only shows the mobile device data APIs 122 and the tracking APIs 124, the system 100 can include other types of APIs. For example, for a given organization, the system 100 can include APIs that integrate with an organization's software, website, and intranet. Other example APIs include APIs that integrate with the market insights portal 108 and the marketplace portal 110.

The above-described features of the system 100 provide insight into an organization's mobile device return process in a limited number of interfaces. As mentioned above, the system 100 helps increase the rate of return of an organization's replaced or to-be replaced assets (e.g., mobile devices). The system 100 also increases the monetary value returned on a device-by-device level by providing insight into incoming inventory. Typical asset buy-back companies do not have insight into details (e.g., make, model, shipping progress, end-user information) of incoming mobile devices. As such, asset buy-back companies sell inventory in mixed lots where, for example, a broken old Blackberry is sold alongside an iPhone 6 in great condition. Mixed lots are sold at prices discounted from the cumulative value of each individual mobile device contained in the mixed lot. Because the system 100 provides increased predictability of incoming mobile devices, the system 100 enables mobile devices to be sold individually or in lots of similarly priced mobile devices such that the sales garner greater returns for both the organization and reseller.

The system administration interface 116 is intended to give users, such as employees of the owner of the mobile device management system 100, access to the system administration portal 106 to manage the system 100.

The market insights interface 118 is intended to give users, such as an organization's IT or asset-recovery employees, access to the market insights portal 108. The market insights portal 108 includes a variety of tools and databases that help organizations optimize mobile device returns. For example, the data provided by the market insights portal 108 can inform an organization as to potentially optimal times to refresh their employees' mobile devices. The market insights portal 108 can include a fair market value database that contains real-time current, past, and estimated future values for various mobile device models and conditions. The fair market value database includes data relating to real-time fair market value of mobile devices, aggregated mobile devices selling prices (which can be updated in real time or daily) from internal/external sales. By accessing the market insights portal 108 through the market insights interface 118, users can see past pricing trends of mobile devices and estimated pricing trends (e.g., future depreciation) of mobile devices. The market insights portal 108 also includes tools for estimating the value of individual mobile devices or bulk lots of mobile devices and providing quotes.

The marketplace interface 120 can also provide users, such as users looking to purchase returned mobile devices, access to current and future inventory of mobile devices. The marketplace interface 120 (and marketplace portal 110) can also provide such users with the ability to submit offers and purchase returned mobile devices.

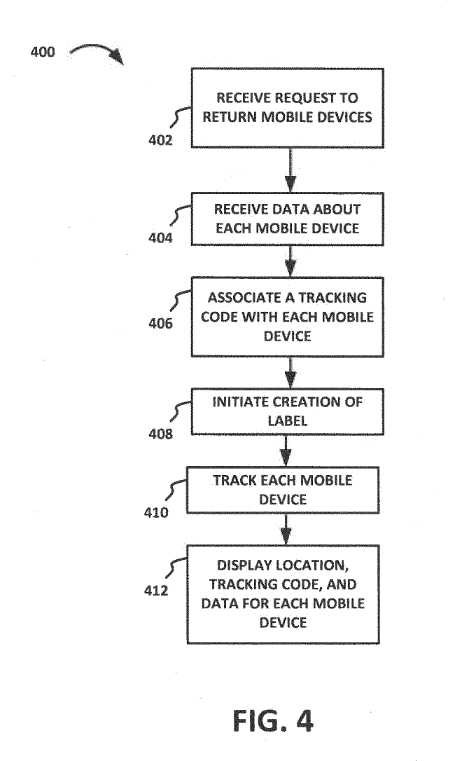

FIG. 4 shows a block representation of steps in a method 400, in accordance with certain embodiments of the present disclosure. The method 400 includes receiving requests to return a plurality of mobile devices (step 402) and receiving data corresponding to a plurality of mobile devices in response to receiving the requests (step 404). The method 400 further includes, in response to receiving the request, associating a tracking code for each of the plurality mobile devices with the received data that corresponds to each of the plurality of mobile devices (step 406). The method 400 further includes initiating creation of a logistics label associated with the tracking code of each of the plurality of mobile devices (step 408) and tracking location of each of the plurality of mobile devices (step 410). The method 400 includes displaying, through a user interface, the location of each of the plurality of mobile devices, the tracking code of each of the plurality of mobile devices, and at least a portion of the received data corresponding to each of the plurality of mobile devices (step 412).

The system 100 and its various features, components, and functions can be implemented in and/or can include one or more computing devices (e.g., personal computer, laptop, server). For example, the system 100 may be implemented using firmware, integrated circuits, and/or software modules within the one or more computing devices that interact with each other or are combined together. In certain embodiments, the methods and functions disclosed above can be implemented using computer- readable instructions/code that are stored in the at least one memory 128 (e.g., one or more non-volatile computer-readable storage medium) for execution by the at least one processor 126.

The memory 128 for performing certain embodiments of the present disclosure may include computer-readable program code portions, such as a series of computer instructions, embodied in the computer-readable medium. It should be understood that the computer-readable program code portions may include separate executable portions for performing distinct functions to accomplish embodiments of the present disclosure. Additionally, or alternatively, one or more of the computer-readable program portions may include one or more executable portions for performing more than one function to thereby accomplish embodiments of the process of the present disclosure.

Various modifications and additions can be made to the embodiments disclosed without departing from the scope of this disclosure. For example, while the embodiments described above refer to particular features, the scope of this disclosure also includes embodiments having different combinations of features and embodiments that do not include all of the described features. Accordingly, the scope of the present disclosure is intended to include all such alternatives, modifications, and variations as falling within the scope of the claims, together with all equivalents thereof.

We claim:

1. A system for managing return of a plurality of mobile devices, the system comprising:
a customer administration portal communicatively coupled to a customer administration interface, a mobile device data application program interface (API), and a tracking API,
wherein the customer administration portal is configured to receive information corresponding to each of the plurality of mobile devices via the mobile device data API,
wherein the customer administration portal is configured to receive a tracking code associated with each of the plurality of mobile devices and a location of each of the plurality of mobile devices via the tracking API,
wherein the customer administration portal is configured to associate the information corresponding to each of the plurality of mobile devices with the tracking code and the location of each of the plurality of mobile devices, and
wherein the customer administration interface is configured to generate a display of the location of each of the plurality of mobile devices, the tracking code of each of the plurality of mobile devices, and at least a portion of the received data corresponding to each of the plurality of mobile devices.

2. The system of claim 1, wherein the customer administration portal and the customer administration interface are stored on one or more servers.

3. The system of claim 1, wherein the customer administration portal is configured to initiate creation of a logistics label associated with the tracking code of each of the plurality of mobile devices.

4. The system of claim 1, wherein the customer administration portal is configured to initiate transmission of the logistics label automatically in response to receiving the tracking code from the tracking API.

5. The system of claim 1, wherein the customer administration interface is configured to display the mobile devices that have been identified to be replaced but have not yet been shipped.

6. The system of claim 1, wherein customer administration portal is configured to periodically transmit reminders to mobile device users who have not shipped their mobile device.

7. The system of claim 1, wherein the received data corresponding to each of the plurality of mobile devices includes a make, model, and/or storage capacity of the plurality of mobile devices.

8. The system of claim 1, wherein the customer administrative interface 114 is configured to display which mobile devices are in transit, which mobile devices have been received by a processing center, which mobile devices are being processed by the processing center, and which mobile devices have been processed.

9. A method comprising:
receiving requests to return a plurality of mobile devices, each request corresponding to at least one of the plurality of mobile devices;
receiving data corresponding to each of the plurality of mobile devices in response to receiving the requests;
associating a tracking code, in response to receiving the request, for each of the plurality mobile devices with the received data corresponding to each of the plurality of mobile devices;
initiating creation of a logistics label associated with the tracking code of each of the plurality of mobile devices;
tracking a location of each of the plurality of mobile devices; and
displaying, through a user interface, the location of each of the plurality of mobile devices, the tracking code of each of the plurality of mobile devices, and at least a portion of the received data corresponding to each of the plurality of mobile devices.

10. The method of claim 9, further comprising:
receiving an indication that at least one of the plurality of mobile devices has been received; and
initiating payment for the at least one mobile device that has been received.

11. The method of claim 10, wherein displaying through the user interface further includes displaying payment price for the at least one mobile device received.

12. The method of claim 10, further comprising:
determining a cumulative estimated value of mobile devices that have not been processed; and
displaying the determine cumulative estimated value.

13. The method of claim 9, further comprising:
determining that a subset of the plurality of mobile devices requested for return have not been shipped.

14. The method of claim 13, further comprising:
transmitting reminders to end users associated with the subset of the plurality of mobile devices.

15. The method of claim 14, wherein the transmitting reminders repeats for end users associated with mobile devices requested for return that have not been shipped.

16. The method of claim 15, wherein the transmitting reminders is repeated at predetermined intervals.

17. The method of claim 13, wherein displaying through the user interface further includes displaying end users associated with the subset of the plurality of mobile devices.

18. The method of claim 9, wherein data corresponding to a plurality of mobile devices is received from at least one a mobility management program and third party database, via an program interface.

19. The method of claim 9, wherein initiating creation of a logistics label is performed automatically in response to receiving a tracking code.

20. The method of claim 19, further comprising:
generating a unique identification code associated with the tracking code; and
transmitting the unique identification code to a third party.
